(19) United States
(12) Patent Application Publication
(10) Pub. No.: US 2025/0314349 A1
(43) Pub. Date: Oct. 9, 2025

(54) CRADLE FOR HOLDING AN ELECTRONIC DEVICE

(71) Applicant: Hand Held Products, Inc., Charlotte, NC (US)

(72) Inventors: Yu WU, Charlotte, NC (US); Zhe CHEN, Charlotte, NC (US); Ke ZHOU, Charlotte, NC (US)

(21) Appl. No.: 19/088,142

(22) Filed: Mar. 24, 2025

(30) Foreign Application Priority Data
Apr. 8, 2024 (CN) 202410414272.X

(51) Int. Cl. F16M 13/02

(52) U.S. Cl. CPC F16M 13/022; F16M 2200/028

(57) ABSTRACT

A cradle configured to hold an electronic device is disclosed. The cradle comprising a hook positioned at least partially within a housing. The hook comprising a first portion having a first elongated member and an elongated cavity and a second portion having a second elongated member. A spring is disposed within the elongated cavity of the hook, and a cam is movably connected to the hook and having a first locking pit and a second locking pit. When the cradle is positioned in a horizontal orientation, the hook is engaged with the first locking pit. When the cradle is moved from the horizontal orientation to a vertical orientation, the first elongated member protrudes from the housing and the second elongated member engaged with the second locking pit. Thereafter, the first elongated member is configured to engage with the electronic device to prevent the electronic device from falling from the cradle.

### CROSS-REFERENCE TO RELATED APPLICATIONS

This application claims priority pursuant to 35 U.S.C. 119 (a) to Chinese Application No. 202410414272.X, filed Apr. 8, 2024, which application is incorporated herein by reference in its entirety.

### TECHNOLOGICAL FIELD

An example embodiment relates generally to a holder, and more particularly relates to a cradle and method for holding an electronic device.

### BACKGROUND

A cradle is a type of docking station or a holder designed to securely hold and charge an electronic device, such as a handheld scanner, when not in use. Typically, the cradle is used in various industries such as retail, healthcare, logistics, and manufacturing to enhance workflow efficiency and device management. Sometimes, it is desirable for the cradle to be positioned horizontally on a surface, such as a desk or tabletop, whereas other times it is desirable for the cradle to be positioned vertically on a wall. Existing technologies often are unable to accommodate positioning the cradle both horizontally and vertically because when the cradle is positioned vertically, the electronic device may unexpectedly drop from the cradle.

Applicant has identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY OF THE INVENTION

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a cradle configured to hold an electronic device is disclosed. The cradle comprising a housing and a hook positioned at least partially within the housing. Further, the hook comprising a first portion having a first elongated member and an elongated cavity. Further, a second portion having a second elongated member. Further, a spring is disposed within the elongated cavity of the hook. Further, a cam is movably connected to the hook and having a first locking pit and a second locking pit. In some embodiments, when the cradle is positioned in a horizontal orientation, the cam is positioned in a first locking position relative to the housing, the hook is suppressed by the spring, and the second elongated member of the hook is engaged with the first locking pit of the cam.

In some embodiments, when the cradle is moved from the horizontal orientation to a vertical orientation, the cam switches from the first locking position to a second locking position relative to the housing under an effect of gravity. In some embodiments, when the cradle is positioned in the vertical orientation, the first elongated member of the hook protrudes from the housing of the cradle and the second elongated member of the hook is engaged with the second locking pit to lock of the cam. In some embodiments, the first elongated member of the hook is configured to engage with the electronic device when the first elongated member protrudes from the housing to prevent the electronic device from falling from the cradle.

In some embodiments, the first locking pit has a first depth and the second locking pit has a second depth, and wherein the first depth is greater than the second depth.

In some embodiments, when the cradle is moved from the horizontal orientation to the vertical orientation, the housing rotates relative to the cam and on an axis that extends through the cam. The cam defines an upward direction and a downward direction, and the first locking pit is positioned upward from the axis.

In some embodiments, the second locking pit is positioned ninety degrees from the first locking pit relative to the axis.

In some embodiments, the cam further comprises an involute portion positioned on a periphery of the cam and between the first locking pit and the second locking pit. Further, when the involute portion comes in contact with the second elongated member of the hook, the first elongated member of the hook protrudes from the housing.

In some embodiments, when the cradle is moved from the horizontal orientation to the vertical orientation, the housing rotates relative to the cam and on an axis that extends through the cam, and wherein the cam defines a center of mass (COM) point that is offset from the axis. In some embodiments, when the COM point that is offset from the axis prevents rotation of the cam.

In some embodiments, the cam further comprises a first bump positioned in proximity to the first locking pit and a second bump positioned in proximity to the second locking pit. Further, the first bump and the second bump are configured to restrict further movement of the second elongated member when the cam switches position under the effect of gravity.

In some embodiments, the cam comprises an indentation that is positioned between the first locking pit and the second locking pit. In some embodiments, the first locking pit and the second locking pit define a radius of curvature of Rb and Ra respectively and the second elongated member of the hook defines a radius of curvature Y.

In another example embodiment, a method is disclosed. The method comprises suppressing, via a spring, a hook positioned at least partially within a housing when a cradle is positioned in a horizontal orientation and a cam is positioned in a first locking position relative to the housing, to engage a second elongated member of the hook with a first locking pit of the cam. Further, the method comprises switching the cam from the first locking position to a second locking position relative to the housing under an effect of gravity when the cradle is moved from the horizontal orientation to a vertical orientation, to allow the first elongated member of the hook to protrude from the housing of the cradle and engage the second elongated member of the hook with a second locking pit of the cam. Thereafter, the method comprises engaging the first elongated member of the hook with an electronic device when the first elongated member protrudes from the housing to prevent the electronic device from falling from the cradle.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a side view of an electronic device placed over a cradle when the cradle is in a horizontal orientation in accordance with an example embodiment of the present disclosure;

FIG. 2A illustrates a sectional view of a housing in accordance with the example embodiment of the present disclosure;

FIG. 2B illustrates a side view of a cam in accordance with the example embodiment of the present disclosure;

FIG. 3 illustrates a sectional view of a portion of the cradle showing the cam positioned in a first locking position relative to the housing when the cradle is positioned in the horizontal orientation in accordance with the example embodiment of the present disclosure;

FIG. 4A illustrates a side view of the electronic device placed over the cradle when the cradle is in the vertical orientation in accordance with the example embodiment of the present disclosure; and,

FIG. 4B illustrates a sectional view of a portion of the cradle showing the cam positioned in a second locking position relative to the housing when the cradle is positioned in the vertical orientation in accordance with the example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a cradle configured to hold an electronic device is disclosed. Embodiments may allow to switch a locking position in accordance to an orientation of an electronic device engaged to the cradle. Embodiments may allow to detachably engage or disengage the electronic device as per the orientation of the cradle. Embodiments may allow the electronic device to be detachably engaged with the cradle in a secure manner when the cradle is placed in a horizontal orientation. Embodiments may allow the electronic device to be detachably engaged with the cradle in the secure manner when the cradle is placed in a vertical orientation.

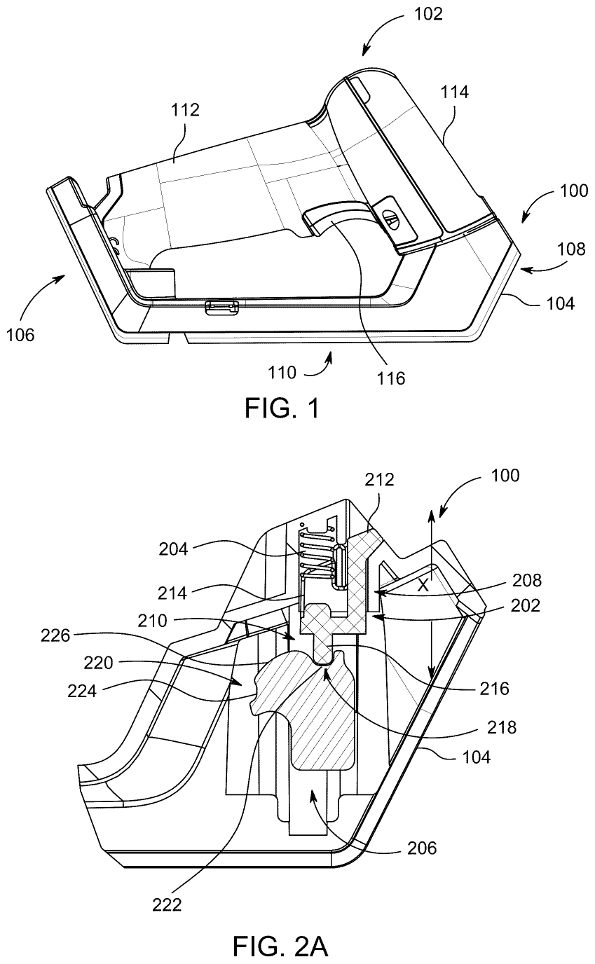

FIG. 1 illustrates a side view of an electronic device 102 placed over a cradle 100 when the cradle 100 is in a horizontal orientation, in accordance with an example embodiment of the present disclosure.

In some embodiments, the cradle 100 may be configured to place and hold the electronic device 102 in the horizontal orientation or in a vertical orientation. The cradle 100 may comprise a housing 104. The housing 104 may comprise a first end 106, a second end 108, and a middle portion 110. The first end 106 and the second end 108 of the housing 104 may be detachably coupled to the electronic device 102. In some embodiments, the middle portion 110 may be configured to connect the first end 106 and the second end 108. In some embodiments, the cradle 100 may be used as a base for keeping the electronic device 102. Further, the cradle 100 may be configured to charge the electronic device 102 while the electronic device 102 is securely placed and connected with the first end 106 and the second end 108 of the housing.

Further, the electronic device 102 may comprise a handle 112, a scanner head 114, and a trigger 116. In some embodiments, the handle 112 of the electronic device 102 may be detachably coupled to the first end 106 of the housing. The handle 112 may be configured to allow a user to hold the electronic device 102 during an operation. Further, the handle 112 may be attached to the scanner head 114. The scanner head 114 may be integrated with a laser light or a scanner light configured to read a bar code or a radio frequency identification (RFID) tag. Further, the handle 112 may be integrated with the trigger 116. The trigger 116 may be pressed or released by the user to control the operation of the scanner head 114. In some embodiments, the scanner head 114 may be detachably position over the second end 108 of the housing 104.

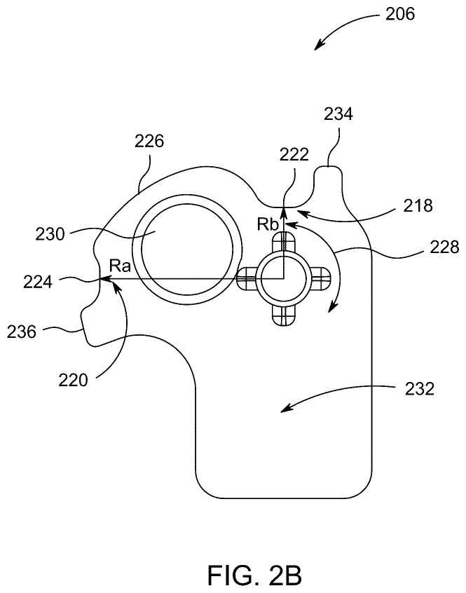

FIG. 2A illustrates a sectional view of the housing 104, in accordance with an example embodiment of the present disclosure. FIG. 2B illustrates a side view of a cam 206, in accordance with an example embodiment of the present disclosure.

In some embodiments, the cradle 100 may comprise a housing 104, a hook 202, a spring 204, and a cam 206. The cam 206 may be configured to rotate on an axis 228 (extending in and out of the page) relative to the housing. In some embodiments, the hook 202 may be positioned partially within the housing 104. Further, the hook 202 may comprise a first portion 208 and a second portion 210. The first portion 208 of the hook 202 may comprise a first elongated member 212 and an elongated cavity 214. Further, the second portion 210 may comprise a second elongated member 216. Further, the spring 204 may be disposed partially within the elongated cavity 214 of the hook 202. In some embodiments, the spring 204 may be positioned inside the housing 104 such that one end of the spring 204 may be integrated within the elongated cavity 214 of the hook 202 and other end may be fixedly attached to an inner surface of the housing 104.

Further, the cam 206 may comprise a first locking pit 218 and a second locking pit 220. In some embodiments, the first locking pit 218 may comprise a first depth 222 and the second locking pit 220 may have a second depth 224. In some embodiments, the first depth 222 may be greater than the second depth 224. Further, the first locking pit 218 and the second locking pit 220 may define a radius of curvature of Rb and Ra respectively and the second elongated member of the hook defines a radius of curvature Y. In some embodiments, a difference between the radius of curvature of the first locking pit 218 Rb and the radius of curvature of the second locking pit 220 Ra may correspond to motion displacement (x) of the hook 202 as shown in the FIG. 2B. Further, the radius of curvature Y of the second elongated member may be relative to the radius of curvature Rb and Ra. In some embodiments, the second locking pit 220 may be positioned ninety degrees from the first locking pit 218 relative to the axis 228. In some embodiments, the axis 228 of the cam 206 may be defined as a point and the housing 104 may rotate relative to the cam 206 in the horizontal orientation or in the vertical orientation. In some embodiments, the first locking pit 218 may be configured to be positioned upward from the axis 228.

In some embodiments, the cam 206 may further comprise an involute portion 226. The involute portion 226 may be positioned on a periphery of the cam 206 and between the first locking pit 218 and the second locking pit 220. Further, the cam 206 may be fabricated with an indentation 230 as illustrated in FIG. 2B. In some embodiments, the indentation 230 may be configured to reduce the weight of the cam 206 in that area and offset a center of mass (COM) 232 of the cam 206 away from the axis of rotation 228. In some embodiment, the COM 232 of the cam 206 that is offset from the axis of rotation 228 may allow the cam 206 to resist changing orientation when the cradle is moved from a horizontal orientation to a vertical orientation, and vice-versa. In some embodiments, the cam 206 further comprises a first bump 234 and a second bump 236. The first bump 234 may be positioned in proximity to the first locking pit 218 and the second bump 236 may be positioned in proximity to the second locking pit 220. In some embodiments, the first bump 234 and the second bump 236 may be configured to restrict further movement of the second elongated member 216 when the cam 206 switches position under the gravity.

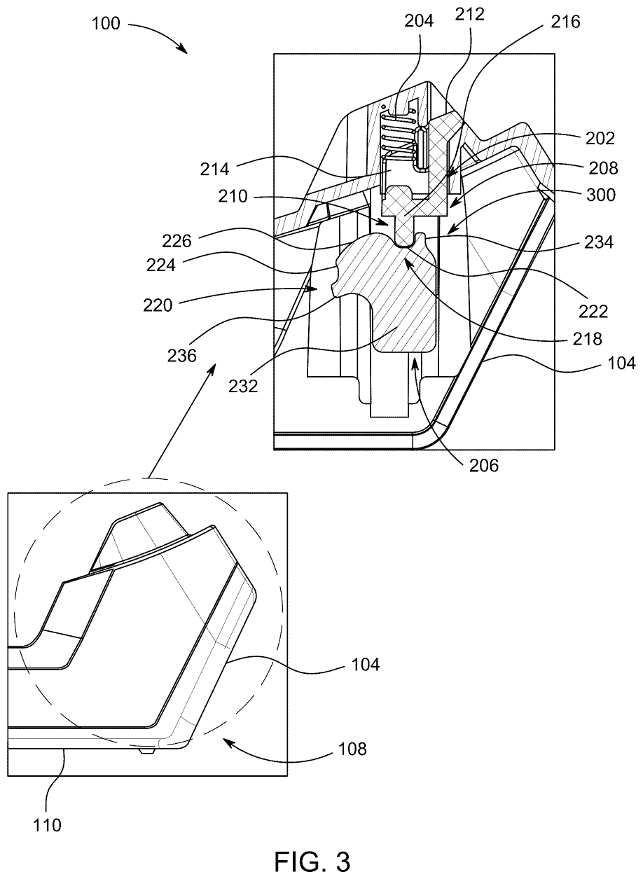

FIG. 3 illustrates a sectional view of a portion of the cradle 100 showing the cam 206 positioned in a first locking position 300 relative to the housing 104 when the cradle 100 is positioned in the horizontal orientation, in accordance with an example embodiment of the present disclosure.

In some embodiments, when the cradle 100 is positioned in the horizontal orientation, the cam 206 may be configured to be positioned in the first locking position 300 relative to the housing 104. Further, the first locking position 300 of the cam 206 corresponds to a position when the second elongated member 216 of the hook 202 may be engaged with the first locking pit 218 of the cam 206. In some embodiments, the spring 204 may be configured to provide a compression force on the hook 202. Further, the hook 202 may be configured to be suppressed due to the compression force applied by the spring 204. In some embodiments, the hook 202 may be configured to transmit the compression force towards the second elongated member 216. In some embodiments, the second elongated member 216 may be configured to suppress in the downward direction due to the compression force experienced by the hook 202. Further, the second elongated member 216 may be configured to engage within the first locking pit 218 of the cam 206 due to the compression force of the spring 204 on the hook 202.

In some embodiments, the second elongated member 216 may be configured to engage within the first locking pit 218 of the cam 206 to lock the hook 202 and the cam 206 in the first locking position 300 relative to the housing 104. Further, when the cam 206 is in the first locking position 300, the first elongated member 212 may be configured to be in a non-protruded state. In some embodiments, the non-protruded state of the first elongated member 212 may be due to the locking of the hook 202 and the cam 206 in the first locking position 300 relative to the housing 104. Further, the non-protruded state of the first elongated member 212 may be configured to allow the electronic device 102 to be lift off from the cradle 100.

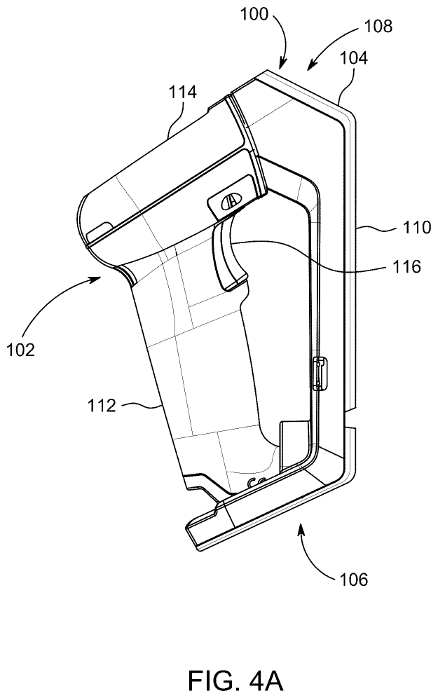

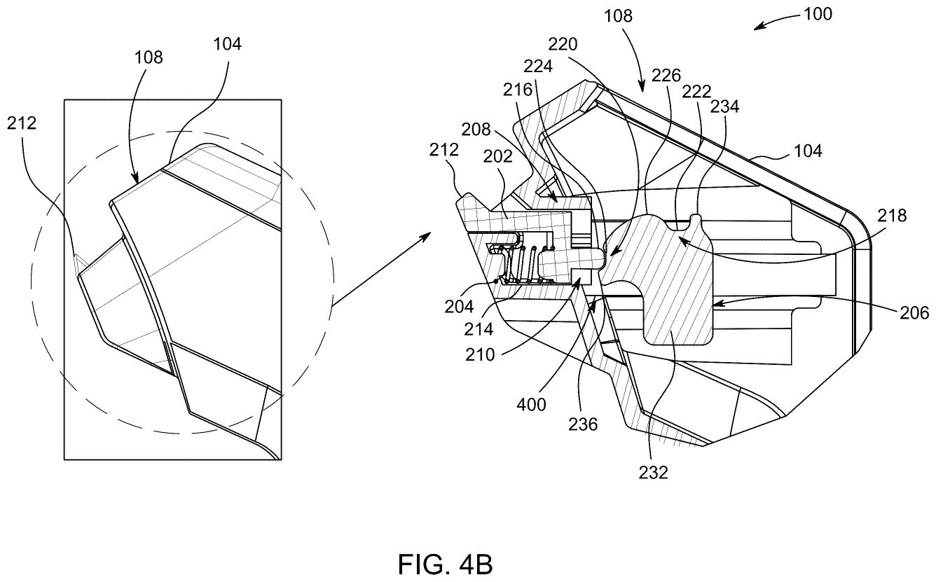

FIG. 4A illustrates a side view of the electronic device 102 placed over the cradle 100 when the cradle 100 is in the vertical orientation, in accordance with an example embodiment of the present disclosure. FIG. 4B illustrates a sectional view of a portion of the cradle 100 showing the cam 206 positioned in a second locking position 400 relative to the housing 104 when the cradle 100 is positioned in the vertical orientation, in accordance with an example embodiment of the present disclosure.

In some embodiments, when the cradle 100 is moved from the horizontal orientation to the vertical orientation, the cam 206 switches from the first locking position 300 to the second locking position 400 relative to the housing 104 under an effect of gravity. Further, when the cradle 100 is moved from the horizontal orientation to the vertical orientation, the housing 104 rotates relative to the cam 206 and on the axis 228 that extends through the cam 206. In some embodiments, when the cradle 100 is turned in the vertical orientation, the cam 206 experiences a gravitational pull. Further, since the COM 232 is offset from the axis 228 of the cam 206, the weight distribution of the cam 206 is irregular. Further, this irregular weight distribution of the cam 206 allows the cam 206 to switch from the first locking position 300 to the second locking position 400.

In some embodiments, the switching of the cam 206 may allow the second elongated member 216 to slide over the cam 206 due to the relative movement of the cam 206 with the housing 104. Further, sliding of the second elongated member 216 may facilitate to disengage the second elongated member 216 from the first locking pit 218. Further, after disengaging, the second elongated member 216 may slide over the involute portion 226 of the cam 206. The involute portion 226 of the cam 206 may facilitate to push the second elongated member 216 followed by the hook 202 towards the spring 204. Further, the pushing of the second elongated member 216 and the hook 202 towards the spring 204 may allow the spring 204 to compress. The compression of the spring 204 may facilitate to store a potential energy within the spring 204.

Further, due to the imbalance in the weight of the cam 206 via the COM 232 being offset from the axis 228 of rotation, the second elongated member 216 may further slide over the involute portion 226 of the cam 206. Further, once the second elongated member 216 reaches over the second locking pit 220, the potential energy stored within the spring 204 may convert into a kinetic energy due to the second depth 224 of the second locking pit 220. The release of the kinetic energy allows the spring 204 to expand and push back the hook 202. Further, pushing of the hook 202 facilitates the second elongated member 216 to get engaged with the second locking pit 220. The second elongated member 216 engaged with the second locking pit 220 may result in positioning the cam 206 in the second locking position 400.

In some embodiments, the second bump 236 may be positioned in proximity to the second locking pit 220 of the cam 206. The second bump 236 may be configured to restrict the further movement of the second elongated member 216 while sliding over the cam 206. In some embodiments, the cam 206 when positioned in the second locking position 400 may further facilitate the first elongated member 212 of the hook 202 to protrude outside the housing 104 as illustrated in FIG. 4B. The first elongated member 212 of the hook 202 protruded outside the housing 104 may further engage with the electronic device 102 to prevent the electronic device 102 from falling from the cradle 100.

In some embodiments, a method is disclosed for holding the electronic device 102 with the cradle 100. At first, the hook 202 is suppressed by the spring 204 when the cradle 100 is positioned in the horizontal orientation and the cam 206 is positioned in the first locking position 300 relative to the housing 104, to engage the second elongated member 216 of the hook 202 with the first locking pit 218 of the cam 206. In some embodiments, spring 204 is placed between the elongated cavity 214 in the compressed state. The spring 204 when in the compressed states, pushes the hook 202 and the second elongated member 216 towards the cam 206. Further, the force induced by the spring 204 enables the second elongated member 216 to engage with the first locking pit 218 of the cam 206.

Further, the cam 206 switches from the first locking position 300 to the second locking position 400 relative to the housing 104 under the effect of gravity when the cradle 100 is moved from the horizontal orientation to the vertical orientation, to allow the first elongated member 212 of the hook 202 to protrude from the housing 104 of the cradle 100 and engage the second elongated member 216 of the hook 202 with the second locking pit 220 to lock the electronic device 102 with the cradle 100.

In some embodiments, when the cradle 100 is moved from the horizontal orientation to the vertical orientation, the cam 206 switches from the first locking position 300 to the second locking position 400 relative to the housing 104 under an effect of gravity. In some embodiments, when the cradle 100 is turned in the vertical orientation, the cam 206 experiences a gravitational pull. Further, the offset COM 232 of the cam 206 allows the cam 206 to switch from the first locking position 300 to the second locking position 400.

In some embodiments, the switching of the cam 206 may allow the second elongated member 216 to slide over the cam 206. Further, sliding of the second elongated member 216 may facilitate to disengage the second elongated member 216 from the first locking pit 218 and engage with the second locking pit 220 that results in positioning the cam 206 in the second locking position 400.

Further, the second bump 236 may be configured to restrict the further movement of the second elongated member 216 while sliding over the cam 206. In some embodiments, the cam 206 when positioned in the second locking position 400 may further facilitate the hook first elongated member 212 of the hook 202 to protrude outside the housing 104 as illustrated in FIG. 4B. The first elongated member 212 of the hook 202 protruded outside the housing 104 may further engage with the electronic device 102 to prevent the electronic device 102 from falling from the cradle 100.

The present disclosure involves the cradle 100 for holding the electronic device 102. The cradle 100 may be configured to provide secure engagement and/or disengagement of the electronic device 102. Embodiments may allow the electronic device 102 to be disengaged from the hook 202 of the cradle 100 when the cradle 100 is positioned in horizontal orientation. Embodiments may allow the electronic device 102 to be engaged with the hook 202 of the cradle 100 when the cradle is positioned in the vertical orientation. Embodiments may prevent the electronic device 102 from falling from the cradle 100 when the cradle 100 is moved from the horizontal orientation to the vertical orientation due to the hook 202 moving from a non-protruded position to a protruded position as the cradle 100 is moved from the horizontal orientation to the vertical orientation.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A cradle configured to hold an electronic device, the cradle comprising:
a housing;
a hook positioned at least partially within the housing, the hook comprising:
a first portion having a first elongated member and an elongated cavity; and
a second portion having a second elongated member;
a spring disposed within the elongated cavity of the hook; and
a cam movably connected to the hook and having a first locking pit and a second locking pit,
wherein when the cradle is positioned in a horizontal orientation, the cam is positioned in a first locking position relative to the housing, the hook is suppressed by the spring, and the second elongated member of the hook is engaged with the first locking pit of the cam,
wherein when the cradle is moved from the horizontal orientation to a vertical orientation, the cam switches from the first locking position to a second locking position relative to the housing under an effect of gravity,
wherein when the cradle is positioned in the vertical orientation, the first elongated member of the hook protrudes from the housing of the cradle and the second elongated member of the hook is engaged with the second locking pit of the cam, and
wherein the first elongated member of the hook is configured to engage with the electronic device when the first elongated member protrudes from the housing to prevent the electronic device from falling from the cradle.

2. The cradle of claim 1, wherein the first locking pit has a first depth and the second locking pit has a second depth, and wherein the first depth is greater than the second depth.

3. The cradle of claim 1, wherein when the cradle is moved from the horizontal orientation to the vertical orientation, the housing rotates relative to the cam and on an axis that extends through the cam, wherein the cam defines an upward direction and a downward direction, and wherein the first locking pit is positioned upward from the axis.

4. The cradle of claim 3, wherein the second locking pit is positioned ninety degrees from the first locking pit relative to the axis.

5. The cradle of claim 1, wherein the cam further comprises an involute portion positioned on a periphery of the cam and between the first locking pit and the second locking pit, and wherein when the involute portion comes in contact with the second elongated member of the hook, the first elongated member of the hook protrudes from the housing.

6. The cradle of claim 1, wherein when the cradle is moved from the horizontal orientation to the vertical orientation, the housing rotates relative to the cam and on an axis that extends through the cam, and wherein the cam defines a center of mass (COM) point that is offset from the axis.

7. The cradle of claim 6, wherein the COM point that is offset from the axis prevents rotation of the cam.

8. The cradle of claim 1, wherein the cam further comprises a first bump positioned in proximity to the first locking pit and a second bump positioned in proximity to the second locking pit, wherein the first bump and the second bump are configured to restrict further movement of the second elongated member when the cam switches position under the effect of gravity.

9. The cradle of claim 1, wherein the cam comprises an indentation that is positioned between the first locking pit and the second locking pit.

10. The cradle of claim 1, wherein the first locking pit and the second locking pit define a radius of curvature of Rb and Ra respectively and the second elongated member of the hook defines a radius of curvature Y.

11. A method comprising:
suppressing, via a spring, a hook positioned at least partially within a housing when a cradle is positioned in a horizontal orientation and a cam is positioned in a first locking position relative to the housing, to engage a second elongated member of the hook with a first locking pit of the cam;
switching the cam from the first locking position to a second locking position relative to the housing under an effect of gravity when the cradle is moved from the horizontal orientation to a vertical orientation, to allow the first elongated member of the hook to protrude from the housing of the cradle and engage the second elongated member of the hook with a second locking pit of the cam; and
engaging the first elongated member of the hook with an electronic device when the first elongated member protrudes from the housing to prevent the electronic device from falling from the cradle.

12. The method of claim 11, wherein the first portion of the hook having an elongated cavity, and the spring disposed within the elongated cavity of the hook.

13. The method of claim 11, wherein the first locking pit has a first depth and the second locking pit has a second depth, and wherein the first depth is greater than the second depth.

14. The method of claim 11, wherein when the cradle is moved from the horizontal orientation to the vertical orientation, the housing rotates relative to the cam and on an axis that extends through the cam, wherein the cam defines an upward direction and a downward direction, and wherein the first locking pit is positioned upward from the axis.

15. The method of claim 14, wherein the second locking pit is positioned ninety degrees from the first locking pit relative to the axis.

16. The method of claim 11, wherein the cam further comprises an involute portion positioned on a periphery of the cam and between the first locking pit and the second locking pit, and wherein when the involute portion comes in contact with the second elongated member of the hook, the first elongated member of the hook protrudes from the housing.

17. The method of claim 11, wherein when the cradle is moved from the horizontal orientation to the vertical orientation, the housing rotates relative to the cam and on an axis that extends through the cam, and wherein the cam defines a center of mass (COM) point that is offset from the axis.

18. The method of claim 17, wherein the COM point that is offset from the axis prevents rotation of the cam.

19. The method of claim 11, wherein the cam further comprises a first bump positioned in proximity to the first locking pit and a second bump positioned in proximity to the second locking pit, wherein the first bump and the second bump are configured to restrict further movement of the second elongated member when the cam switches position under the effect of gravity.

20. The method of claim 11, wherein the cam comprises an indentation that is positioned between the first locking pit and the second locking pit.
